(19) United States
(12) Patent Application Publication
(10) Pub. No.: US 2018/0039150 A1
(43) Pub. Date: Feb. 8, 2018

(54) ELECTROPHORETIC DISPLAY DEVICE

(71) Applicant: E Ink Holdings Inc., HSINCHU (TW)

(72) Inventors: Po-Yuan LO, HSINCHU (TW); Tai-Yuan LEE, HSINCHU (TW)

(21) Appl. No.: 15/597,137

(22) Filed: May 16, 2017

(30) Foreign Application Priority Data
Aug. 5, 2016 (CN) 201610635713.4

(51) Int. Cl. G02F 1/167; G02F 1/1335

(52) U.S. Cl. CPC G02F 1/167; G02F 1/133514; G02F 2202/28

(57) ABSTRACT

An electrophoretic display device includes an electrophoretic display module, a color filter layer, a first adhesive layer, a first protection layer, a second adhesive layer, and a second protection layer. The electrophoretic display module has a first surface and a second surface. The color filter layer is located on the first surface of the electrophoretic display module. The first adhesive layer is located on the color filter layer and between the first protection layer and the color filter layer. The second adhesive layer is located on the second surface of the electrophoretic display module and between the second protection layer and the electrophoretic display module.

### RELATED APPLICATIONS

This application claims priority to Chinese Application Serial Number 201610635713.4, Aug. 5, 2016, which is herein incorporated by reference.

### BACKGROUND

### Field of Invention

The present invention relates to an electrophoretic display device.

### Description of Related Art

In a market with a wide variety of consumer electronic products, electrophoretic display devices have been extensively utilized as display screens in electronic products, such as an electronic book. The electrophoretic display device has a display medium layer that mainly consists of an electrophoresis buffer and white and black charged particles that are doped in the electrophoresis buffer. Under a voltage application to the display medium layer, the white and black charged particles are driven to move, so that each pixel of the display medium layer displays black, white or a gray level. The electrophoretic display device utilizes incident light (e.g., sunlight or indoor ambient light) that irradiates the display medium layer to realize displaying the pixels. Therefore, the electrophoretic display device needs no backlight, which reduces power consumption.

In general, a color electrophoretic display has a color filter layer therein. When incident light is reflected by the display medium layer, the reflected light may pass through the color filter to display a color image. However, if an electrophoretic display device having a large size is in an environment with a high temperature (e.g., 70° C.) and a low relative humidity (e.g., 23%), a protection sheet and optical clear adhesive (OCA) that adheres the protection sheet to the color filter layer would induce a tensile stress to cause warpage, and thus the color filter layer is bent by the tensile stress. As such, color resists at the edge of the color filter layer may be normally displaced 45 μm to 50 μm; users may therefore find a visible color shift at the edge of the color electrophoretic display device though naked eyes.

### SUMMARY

An aspect of the present invention is to provide an electrophoretic display device.

According to an embodiment of the present invention, an electrophoretic display device includes an electrophoretic display module, a color filter layer, a first adhesive layer, a first protection layer, a second adhesive layer, and a second protection layer. The electrophoretic display module has a first surface and a second surface that is opposite to the first surface. The color filter layer is located on the first surface of the electrophoretic display module. The first adhesive layer is located on the color filter layer. The first adhesive layer is located between the first protection layer and the color filter layer. The second adhesive layer is located on the second surface of the electrophoretic display module. The second adhesive layer is located between the second protection layer and the electrophoretic display module.

In one embodiment of the present invention, the first and second protection layers are made of the same material, and the first and second adhesive layers are also made of the same material.

In one embodiment of the present invention, the electrophoretic display device further includes a first barrier layer. The first barrier layer is located between the first protection layer and the first adhesive layer.

In one embodiment of the present invention, the electrophoretic display device further includes a second barrier layer. The second barrier layer is located between the second protection layer and the second adhesive layer.

In one embodiment of the present invention, the first and second barrier layers are made of the same material.

In one embodiment of the present invention, the electrophoretic display device further includes a first ultraviolet (UV) cut layer. The first UV cut layer is located between the first protection layer and the first adhesive layer.

In one embodiment of the present invention, the electrophoretic display device further includes a second UV cut layer. The second UV cut layer is located between the second protection layer and the second adhesive layer.

In one embodiment of the present invention, the first and second UV cut layers made of the same material.

In one embodiment of the present invention, the electrophoretic display module includes a front substrate, an array substrate, and a display medium layer. The display medium layer is located between the array substrate and the front substrate.

In one embodiment of the present invention, the front substrate has the first surface that faces away from the display medium layer.

In one embodiment of the present invention, the color filter layer, the first adhesive layer, and the first protection layer are stacked on the first surface of the front substrate in sequence.

In one embodiment of the present invention, the array substrate has the second surface that faces away from the display medium layer.

In one embodiment of the present invention, the second adhesive layer and the second protection layer are stacked on the second surface of the array substrate in sequence.

In one embodiment of the present invention, the color filter layer comprises a red color resist, a green color resist, and a blue color resist.

In one embodiment of the present invention, the electrophoretic display device has a display area. The length of the diagonal line of the display area is in a range from 30 inches to 45 inches.

In the aforementioned embodiment of the present invention, since the electrophoretic display device has the first adhesive layer and the first protection layer that are located on the first surface of the electrophoretic display module, and further has the second adhesive layer and the second protection layer that are located on the second surface of the electrophoretic display module. As a result of such a design, when the electrophoretic display device is in an environment with a high temperature and a low relative humidity, although the first protection layer and the first adhesive layer may form a tensile stress, the second protection layer and the second adhesive layer may also form another tensile stress. The directions of the two tensile stresses are opposite, and the intensity of the two tensile stresses is the same. Hence, the two tensile stresses may cancel each other out to prevent the color filter layer from being bent. As a result, the displacement of color resists at the edge of the color filter layer is not prone to occur, thereby preventing users from finding a visible color shift at the edge of the electrophoretic display device though naked eyes.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a top view of an electrophoretic display device according to one embodiment of the present invention;

FIG. 2 is a cross-sectional view of the electrophoretic display device taken along line 2-2 shown in FIG. 1;

FIG. 3 is a cross-sectional view of an electrophoretic display device according to one embodiment of the present invention;

FIG. 4 is a cross-sectional view of an electrophoretic display device according to one embodiment of the present invention; and

FIG. 5 is a cross-sectional view of an electrophoretic display device according to one embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

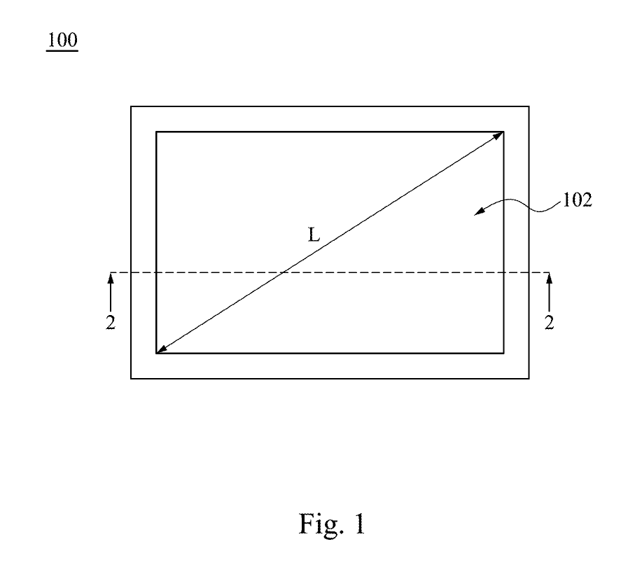

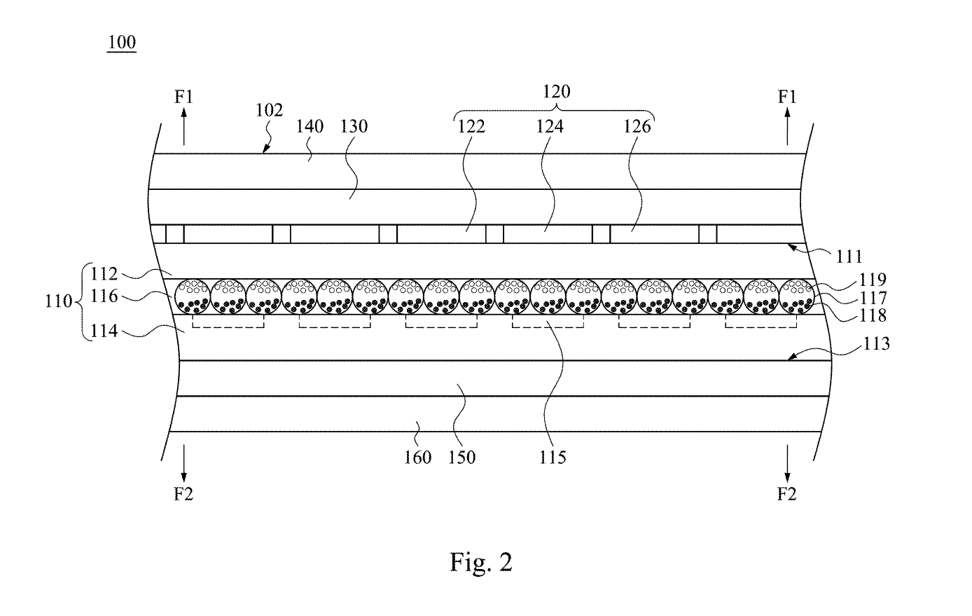

FIG. 1 is a top view of an electrophoretic display device 100 according to one embodiment of the present invention. FIG. 2 is a cross-sectional view of the electrophoretic display device 100 taken along line 2-2 shown in FIG. 1. As shown in FIG. 1 and FIG. 2, the electrophoretic display device 100 is a color display device, and has a display area 102. In this embodiment, the length L of the diagonal line of the display area 102 may be greater than 30 inches, such as in a range from 30 inches to 45 inches, but the present invention is not limited in this regard. The electrophoretic display device 100 includes an electrophoretic display module 110, a color filter layer 120, a first adhesive layer 130, a first protection layer 140, a second adhesive layer 150, and a second protection layer 160.

The electrophoretic display module 110 has a first surface 111 and a second surface 113 that is opposite to the first surface 111. The color filter layer 120 is located on the first surface 111 of the electrophoretic display module 110. The first adhesive layer 130 is located on the color filter layer 120. The first protection layer 140 is located on the first adhesive layer 130, such that the first adhesive layer 130 is located between the first protection layer 140 and the color filter layer 120. The second adhesive layer 150 is located on the second surface 113 of the electrophoretic display module 110. The second protection layer 160 is located on the second adhesive layer 150, such that the second adhesive layer 150 is located between the second protection layer 160 and the electrophoretic display module 110. As a result of such a design, the first and second protection layers 140, 160 are configured in a mirror arrangement relative to the electrophoretic display module 110, and the first and second adhesive layers 130, 150 are also configured in a mirror arrangement relative to the electrophoretic display module 110. In this description, “mirror arrangement” is referred to as “symmetrical arrangement”.

In other words, the electrophoretic display device 100 has the first adhesive layer 130 and the first protection layer 140 that are located on the first surface 111 of the electrophoretic display module 110, and further has the second adhesive layer 150 and the second protection layer 160 that are located on the second surface 113 of the electrophoretic display module 110. When the electrophoretic display device 100 is in an environment with a high temperature (e.g., 70° C.) and a low relative humidity (e.g., 23%), although the first protection layer 140 and the first adhesive layer 130 may form a tensile stress F1, the second protection layer 160 and the second adhesive layer 150 may also form another tensile stress F2. The directions of the two tensile stresses F1, F2 are opposite, and the intensity of the tensile stress F1 and the intensity of the tensile stress F2 are the same. Hence, the two tensile stresses F1, F2 may cancel each other out to prevent the color filter layer 120 from being bent. As a result, the displacement of color resists at the edge of the color filter layer 120 may be reduced to less than 20 μm, thereby preventing users from finding a visible color shift at the edge of the electrophoretic display device 100 though naked eyes.

In this embodiment, the first and second protection layers 140, 160 may be made of the same material, and the first and second adhesive layers 130, 150 may be also made of the same material. Therefore, in the same environment condition, the tensile stress F1 formed by the stacked first adhesive layer 130 and first protection layer 140 may be canceled out by the tensile stress F2 that is formed by the stacked second adhesive layer 150 and second protection layer 160. The first and second protection layers 140, 160 may be made of polyethylene terephthalate (PET), and the first and second adhesive layers 130, 150 may be made of optical clear adhesive (OCA), but the present invention is not limited in this regard.

The electrophoretic display module 110 includes a front substrate 112, an array substrate 114, and a display medium layer 116. The display medium layer 116 is located between the array substrate 114 and the front substrate 112. The display medium layer 116 has microcapsules 117, and each of the microcapsules 117 has black particles 118 and white particles 119 therein. The front substrate 112 has the first surface 111 that faces away from the display medium layer 116. The color filter layer 120, the first adhesive layer 130, and the first protection layer 140 are stacked on the first surface 111 of the front substrate 112 in sequence. The array substrate 114 has the second surface 113 that faces away from the display medium layer 116. The second adhesive layer 150 and the second protection layer 160 are stacked on the second surface 113 of the array substrate 114 in sequence.

The color filter layer 120 may include a red color resist 122, a green color resist 124, and a blue color resist 126. However, in another embodiment, the color filter layer 120 may further include a yellow color resist. After incident light enters the electrophoretic display device 100 from the first protection layer 140, the incident light may pass through the color resist of the color filter layer 120, and then the incident light is reflected by the display medium layer 116 that has the microcapsules 117. Thereafter, the light reflected by the medium layer 116 may pass through the color resist of the color filter layer 120 again to display a color image in the display area 102. In this embodiment, the positions of the red color resist 122, the green color resist 124, and the blue color resist 126 may respectively correspond to the positions of the pixel regions 115 of the array substrate 114. In other words, the red color resist 122, the green color resist 124, and the blue color resist 126 may be respectively aligned with the pixel regions 115 of the array substrate 114. As a result of such a configuration, it is helpful for the electrophoretic display device 100 to control images.

It is to be noted that the connection relationships and materials of the aforementioned elements will not be repeated in the following description. In the following description, other types of electrophoretic display devices will be described.

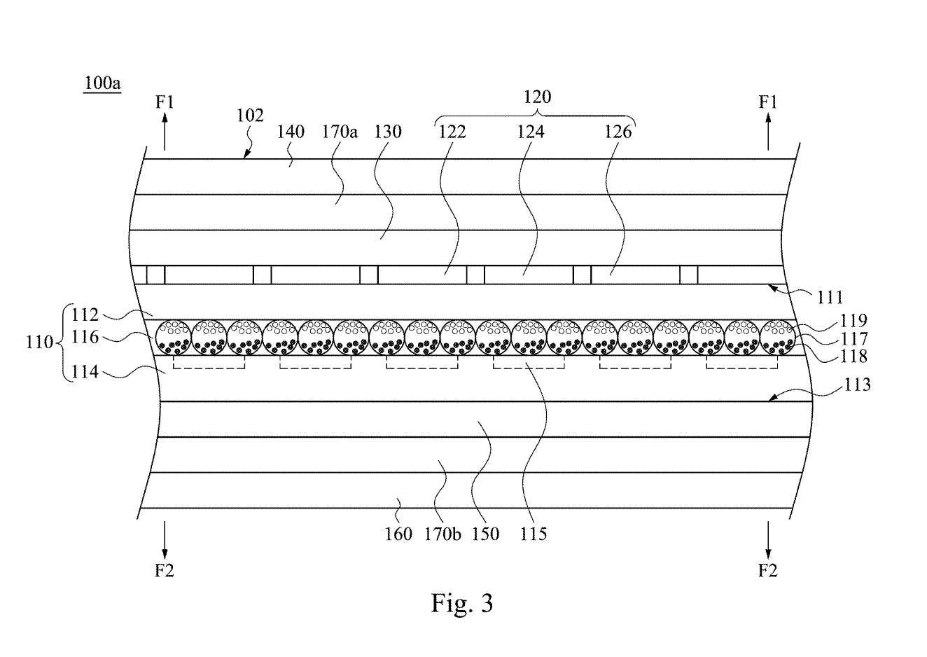

FIG. 3 is a cross-sectional view of an electrophoretic display device 100a according to one embodiment of the present invention. The electrophoretic display device 100a includes the electrophoretic display module 110, the color filter layer 120, the first adhesive layer 130, the first protection layer 140, the second adhesive layer 150, and the second protection layer 160. The difference between this embodiment and the embodiment shown in FIG. 2 is that the electrophoretic display device 100a further includes a first barrier layer 170a and a second barrier layer 170b. The first barrier layer 170a is located between the first protection layer 140 and the first adhesive layer 130. The second barrier layer 170b is located between the second protection layer 160 and the second adhesive layer 150, such that the first and second barrier layers 170a, 170b are configured in a mirror arrangement relative to the electrophoretic display module 110.

The first barrier layer 170a may prevent moisture from entering the color filter layer 120 and the electrophoretic display module 110, thereby extending the lifespan of the electrophoretic display device 100a. In addition, when the electrophoretic display device 100a is in an environment with a high temperature (e.g., 70° C.) and a low relative humidity (e.g., 23%), although the first protection layer 140, the first barrier layer 170a, and the first adhesive layer 130 may form a tensile stress F1, the second protection layer 160, the second barrier layer 170b, and the second adhesive layer 150 may also form another tensile stress F2. The directions of the two tensile stresses F1, F2 are opposite, and the intensity of the tensile stress F1 and the intensity of the tensile stress F2 are the same. Hence, the two tensile stresses F1, F2 may cancel each other out to prevent the color filter layer 120 from being bent.

In this embodiment, the first and second barrier layers 170a, 170b may be made of the same material, such that the tensile stress of the first barrier layer 170a may be canceled out by the tensile stress of the second barrier layer 170b.

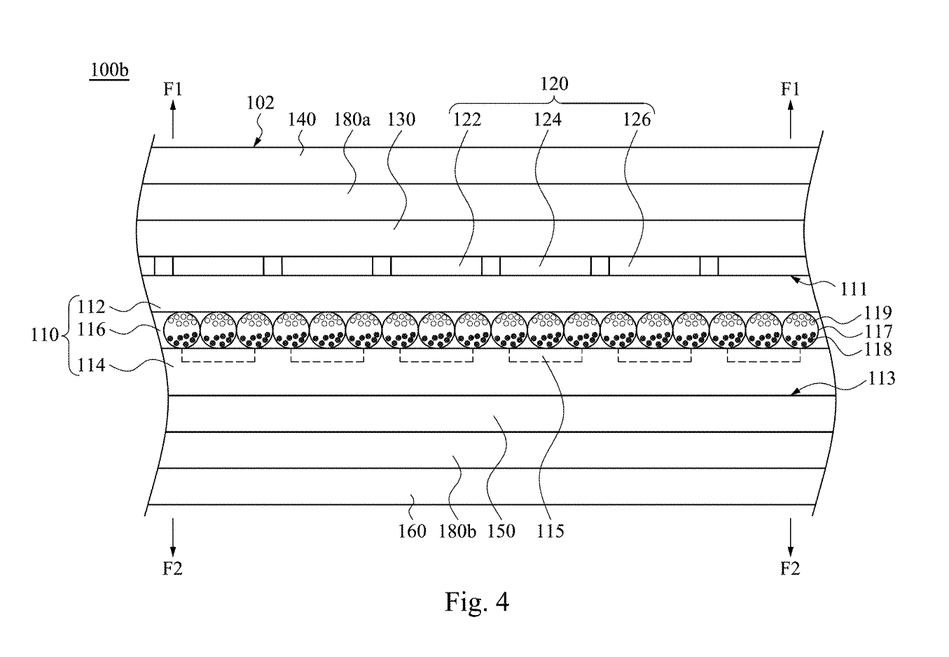

FIG. 4 is a cross-sectional view of an electrophoretic display device 100b according to one embodiment of the present invention. The electrophoretic display device 100b includes the electrophoretic display module 110, the color filter layer 120, the first adhesive layer 130, the first protection layer 140, the second adhesive layer 150, and the second protection layer 160. The difference between this embodiment and the embodiment shown in FIG. 2 is that the electrophoretic display device 100b further includes a first ultraviolet (UV) cut layer 180a and a second UV cut layer 180b. The first UV cut layer 180a is located between the first protection layer 140 and the first adhesive layer 130. The second UV cut layer 180b is located between the second protection layer 160 and the second adhesive layer 150, such that the first and second UV cut layers 180a, 180b are configured in a mirror arrangement relative to the electrophoretic display module 110.

The first UV cut layer 180a may prevent UV light from entering the color filter layer 120 and the electrophoretic display module 110, thereby extending the lifespan of the electrophoretic display device 100b. In addition, when the electrophoretic display device 100b is in an environment with a high temperature (e.g., 70° C.) and a low relative humidity (e.g., 23%), although the first protection layer 140, the first UV cut layer 180a, and the first adhesive layer 130 may form a tensile stress F1, the second protection layer 160, the second UV cut layer 180b, and the second adhesive layer 150 may also form another tensile stress F2. The directions of the two tensile stresses F1, F2 are opposite, and the intensity of the tensile stress F1 and the intensity of the tensile stress F2 are the same. Hence, the two tensile stresses F1, F2 may cancel each other out to prevent the color filter layer 120 from being bent.

In this embodiment, the first and second UV cut layers 180a, 180b may be made of the same material, such that the tensile stress of the first UV cut layer 180a may be canceled out by the tensile stress of the second UV cut layer 180b.

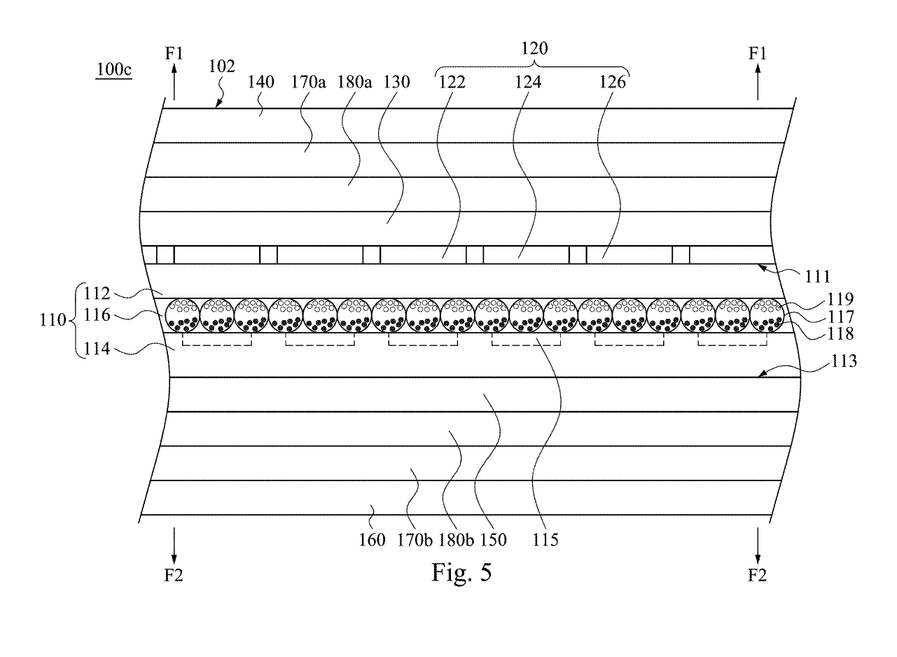

FIG. 5 is a cross-sectional view of an electrophoretic display device 100c according to one embodiment of the present invention. The electrophoretic display device 100c includes the electrophoretic display module 110, the color filter layer 120, the first adhesive layer 130, the first protection layer 140, the second adhesive layer 150, the second protection layer 160, the first barrier layer 170a, and second barrier layer 170b. The difference between this embodiment and the embodiment shown in FIG. 3 is that the electrophoretic display device 100c further includes the first UV cut layer 180a and the second UV cut layer 180b. The first UV cut layer 180a is located between the first barrier layer 170a and the first adhesive layer 130. The second UV cut layer 180b is located between the second barrier layer 170b and the second adhesive layer 150, such that the first and second barrier layers 170a, 170b are configured in a mirror arrangement relative to the electrophoretic display module 110, and the first and second UV cut layer 180a, 180b are also configured in a mirror arrangement relative to the electrophoretic display module 110.

When the electrophoretic display device 100c is in an environment with a high temperature (e.g., 70° C.) and a low relative humidity (e.g., 23%), although the first protection layer 140, the first barrier layer 170a, the first UV cut layer 180a, and the first adhesive layer 130 may form a tensile stress F1, the second protection layer 160, the second barrier layer 170b, the second UV cut layer 180b, and the second adhesive layer 150 may also form another tensile stress F2. The directions of the two tensile stresses F1, F2 are opposite, and the intensity of the tensile stress F1 and the intensity of the tensile stress F2 are the same. Hence, the two tensile stresses F1, F2 may cancel each other out to prevent the color filter layer 120 from being bent.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims.

What is claimed is:

1. An electrophoretic display device, comprising:
an electrophoretic display module having a first surface and a second surface that is opposite to the first surface;
a color filter layer located on the first surface of the electrophoretic display module;
a first adhesive layer located on the color filter layer;
a first protection layer, wherein the first adhesive layer is located between the first protection layer and the color filter layer;
a second adhesive layer located on the second surface of the electrophoretic display module; and
a second protection layer, wherein the second adhesive layer is located between the second protection layer and the electrophoretic display module.

2. The electrophoretic display device of claim 1, wherein the first and second protection layers are made of the same material, and the first and second adhesive layers are made of the same material.

3. The electrophoretic display device of claim 1, further comprising:
a first barrier layer located between the first protection layer and the first adhesive layer.

4. The electrophoretic display device of claim 3, further comprising:
a second barrier layer located between the second protection layer and the second adhesive layer.

5. The electrophoretic display device of claim 4, wherein the first and second barrier layers are made of the same material.

6. The electrophoretic display device of claim 1, further comprising:
a first ultraviolet (UV) cut layer located between the first protection layer and the first adhesive layer.

7. The electrophoretic display device of claim 6, further comprising:
a second UV cut layer located between the second protection layer and the second adhesive layer.

8. The electrophoretic display device of claim 7, wherein the first and second UV cut layers made of the same material.

9. The electrophoretic display device of claim 1, wherein the electrophoretic display module comprises:
a front substrate;
an array substrate; and
a display medium layer located between the array substrate and the front substrate.

10. The electrophoretic display device of claim 9, wherein the front substrate has the first surface that faces away from the display medium layer.

11. The electrophoretic display device of claim 10, wherein the color filter layer, the first adhesive layer, and the first protection layer are stacked on the first surface of the front substrate in sequence.

12. The electrophoretic display device of claim 9, wherein the array substrate has the second surface that faces away from the display medium layer.

13. The electrophoretic display device of claim 12, wherein the second adhesive layer and the second protection layer are stacked on the second surface of the array substrate in sequence.

14. The electrophoretic display device of claim 1, wherein the color filter layer comprises a red color resist, a green color resist, and a blue color resist.

15. The electrophoretic display device of claim 1, further comprising a display area, wherein a length of a diagonal line of the display area is in a range from 30 inches to 45 inches.
